(19) United States
(12) Patent Application Publication
(10) Pub. No.: US 2017/0343117 A1
(43) Pub. Date: Nov. 30, 2017

(54) HIGH-PRESSURE STATIC SEALING

(71) Applicant: ONIS, Lambesc (FR)

(72) Inventor: Yann FUMANAL, Pelissanne (FR)

(73) Assignee: ONIS, Lambesc (FR)

(21) Appl. No.: 15/596,395

(22) Filed: May 16, 2017

(30) Foreign Application Priority Data
May 24, 2016 (FR) 1600829

(51) Int. Cl. F16K 3/02; F16K 3/312; F16J 15/02

(52) U.S. Cl. CPC F16K 3/0227; F16J 15/022; F16K 3/312

(57) ABSTRACT

A static sealing gasket of elastically deformable type, the gasket extending in elevation parallel to an axial direction perpendicular to a join plane, the gasket forming a closed loop around the axial direction and presenting a cross-section in each transverse half-plane of shape making it possible to ensure that the gasket is properly positioned inside a groove of a substantially complementary shape. Such a gasket comprises a body made of elastically deformable material, each cross-section of the gasket at rest being a polygon that is not regular and that is transversely asymmetrical.

### CROSS-REFERENCE TO RELATED APPLICATIONS

This application claims priority to European patent application No. FR 16 00829 filed on May 24, 2016, the disclosure of which is incorporated in its entirety by reference herein.

### BACKGROUND OF THE INVENTION

### (1) Field of the Invention

The invention relates generally to the field of plane sealing between an upstream segment and a downstream segment of a structure having its inside under positive pressure, e.g. a fluid pipe.

Such sealing is said to be static when it is obtained with the upstream segment and the downstream segment rigidly fastened to each other in separable manner.

In the meaning of the invention, static sealing is for “high pressures”, i.e. for positive values of the fluid pressure potentially reaching values of the order of 42 megapascals (MPa) (420 bar) to 75 MPa (750 bar).

In this field, the invention seeks in particular to provide sealing by mounting a gasket that is solid and elastically deformable.

In contrast, a gasket that is plastically deformable is a plane cutout made of crushable material interposed between two plane surfaces between which sealing is to be provided. With such crushable gaskets, obtaining sealing implies irreversible deformation of the gasket.

### (2) Description of Related Art

Conventionally, sealing of the type of the invention, provides for mounting the elastically deformable gasket in a concave groove formed in one of the upstream and downstream segments, in which the gasket is housed. For example, it may be an O-ring made of elastomer. Depending on circumstances, for mounting a gasket that is solid and elastically deformable, the section of the groove may be rectangular, trapezoidal, or sometimes hexagonal.

The invention typically applies to an assembly forming a rapid-action valve (such as a “line blind” valve), and as shown in the following documents: FR 1 264 881, FR 2 288 267, FR 2 323 938, FR 2 447 501, FR 2 672 958, FR 2 733 024, and FR 2 756 346.

Such a valve is used within an industrial installation where fluids under pressure need to be caused to flow through a network of pipes. In the event of the network being maintained or modified, or in an emergency, it is desirable to be capable of isolating two contiguous segments of pipework in a manner that is completely certain and leaktight.

Historically, after interrupting the flow of fluid in the pipe, two flanges for connecting two segments together are moved apart and a solid plate (i.e. a solid wall) is secured between the two flanges across the fluid passage. It is this solid plate that ensures that the sealing is certain.

This operation provides so-called “positive” isolation, avoiding any risk of leakage to which a valve having an internal valve member might be subject, or any risk of false manipulation. Nevertheless, this technique requires means that are considerable in terms of time, mechanical aids (hoists), and labour. For example, in an emergency, or with a pipe that is of large diameter or that is difficult of access, inserting such a plate is not always appropriate.

Furthermore, this operation requires an expensive outage of the industrial installation where the intervention is needed.

Rapid action valves mitigate the drawbacks of installing a plate, and they are therefore commonly permanently mounted on pipework of various diameters (e.g. in the range 25 millimeters (mm) to 1200 mm).

With such rapid action valves, a system of eccentrics makes it possible momentarily to space apart the flanges in order to place between them a sliding plate referred to as a gate. The gate is movable between two positions: an open position in which the pipe facing an opening in the gate passes a fluid flow, and a closed position in which the pipe is shut, as with a plate.

In order to obtain sealing, the gate is provided with reception grooves in each of its faces, and for each of its open and closed positions. An elastically deformable gasket is placed in each of these grooves. Facing each gasket, the corresponding flange possesses a seat that is plane. The system of eccentrics then enables the flanges to be clamped together so that the seats bear against the gaskets and deform them elastically against the gate, thereby providing sealing.

Conventionally, the gate grooves of a rapid action valve are concave and circular in outline in the join plane. Commonly, o-ring gaskets of circular cross section are inserted in respective grooves of corresponding shape. However the cross-section of the groove is sometimes rectangular, hexagonal, or even triangular.

Known gaskets are generally made out of an elastically deformable material such as nitrile rubber, fluorinated rubber, or polyethylene. Other gaskets are made of graphite, of silicone, or indeed of polyurethane, possibly including pieces of metal.

To obtain the elastic deformation, in an axial direction perpendicular to the join plane, the thickness of the gasket at rest is substantially greater than the axial depth of the groove receiving it. Before clamping to obtain sealing, the gasket thus projects out from the groove in the axial direction. On clamping, the gasket deforms elastically and creates sealing surfaces between the seats.

For example, at rest, known seals propose leaving, in a trapezoidal groove, an empty expansion volume for an O-ring, which volume is of the order of 9% to 10%. By way of example, an empty expansion volume for an O-ring in a hexagonal groove may be of the order of 16%. Nevertheless, the way such empty expansion volumes are distributed essentially close to the bottom of the groove is not favourable to the deformable gasket presenting an outline that guarantees reliable sealing against high pressures.

Although known gaskets present numerous qualities and are in widespread use, e.g. for rapid action valve gates, at present other technical problems remain without solutions that are acceptable in practice.

Nowadays, elastically deformable gaskets do not guarantee static sealing that is durable and reliable when the pressure of the fluid in the pipe exceed certain values, e.g. in the range 42 MPa (420 bar) to 75 MPa (750 bar) at least.

Furthermore, during in situ mounting, human error can lead to a model of gasket of inappropriate shape being installed in a groove.

Also, a gasket of shape that is acceptable but that is made of an inappropriate composition of materials also runs the risk of being installed as a result of human error.

It is therefore complicated, or indeed impossible in practice, to be certain that the appropriate gasket is indeed installed in situ, and this can have severe consequences.

In particular for gaskets of noncircular cross-section, such as those described specifically in documents EP 1 764 533, EP 2 143 981, and WO01/79730, it is at present complicated or even impossible to be certain that the gasket is mounted in the groove in a predetermined position and in proper manner, which can also lead to undesirable consequences.

Another aspect illustrated by the example of rapid action valves, is associated with keeping the gasket at rest inside the groove from the moment it is mounted until sealing is obtained by clamping the seats of the flanges against the corresponding faces of the slidable gate. Grooves that are trapezoidal or hexagonal generally provide a certain amount of holding.

Nevertheless, the integrity of the gasket can be spoilt by the gasket being pushed-in forcibly with momentary deformation while it is being inserted into the groove. In particular, the gasket runs the risk of being bruised or damaged in so far as the section shape of the gasket is not circular, but includes projections. In particular for high pressure applications, it is not acceptable for a gasket to be spoiled so as to risk not being capable of performing its sealing function in full. Likewise, it is not acceptable for a gasket to be bruised during mounting, so that it presents incipient breaks.

Furthermore, certain safety procedures require that ageing gaskets should not be left in place. Specifically, certain materials lose their initial qualities over time. Consequently, the effectiveness of a gasket can be guaranteed only under certain conditions and for a given duration. It is thus complicated or even impossible at present to be certain, on site, that the proper gasket has indeed been installed for an appropriate length of time, which likewise can lead to unfortunate consequences.

Also, the gasket needs to be particularly robust and of a structure that is simple and compact, while also being capable of being produced economically, including when producing only limited runs.

In this context, there exist flange gaskets that are designed, for example, for use with flanged hydraulic tubes, pipes, and couplings complying with the SAEJ518C standard. Those gaskets take the place of O-rings without requiring existing housings to be modified(cf: http://de.dichtomatik.com/en/produktkatalog/flachdichtungen/10 f).

Likewise, there exist certain gaskets of T-shaped section (cf: http://fr.prepol.com/produits/joints-en-t-et-joints-en-1). Such T-shaped gaskets provide good static sealing and are made up of an elastomer strip and two bearing rings made of plastics material (polytetrafluoroethylene (PTFE) or poly ether ether ketone (PEEK)). Those rings have an anti-extrusion function making high-pressure use possible, since the pressure of the system is used for driving the bearing rings. Putting such T-shaped gaskets into place is simplified because of their symmetrical shape.

Under such conditions, Document EP 0 187 606 describes a sealing gasket for an assembly with plane faces and a flange connection. That gasket is in the form of a ring and has a molded expanded annular core made of graphite lying between two metal rings. The ring formed by the gasket has two plane parallel faces of the graphite core. The inner and outer metal rings have a spring effect in an axial direction and present an undulating wall having the axial direction as its main direction.

Document FR 2 517 789 describes a composite sealing gasket for joining tubes that are of small diameter and subjected to high temperatures. The gasket has an annular metal core with circular grooves on each of its faces, and a lining of refractory material that possesses selected elastic recovery. A lining is placed in the groove and projects from the face of the gasket so as to be compressed until it comes flush with the metal core during clamping.

Document FR 2 850 153 describes a sealing gasket having a metal outer cover and an elastic internal structure. The internal structure is made up of flexible blades that are superposed and separated by supports. Supports are situated on both sides of the blades, being offset in a staggered configuration.

Documents U.S. Pat. No. 3,260,496, U.S. Pat. No. 3,734,457, WO2013/144167, and WO2016/006802 are also mentioned by way of technological background.

### BRIEF SUMMARY OF THE INVENTION

The invention thus proposes escaping from the above-mentioned limitations.

The invention is useful in numerous industrial applications having severe requirements for safety and for withstanding. Thus, the invention can typically find applications within structures such as openings giving access to pressurized vehicles such as aircraft or submarines. The invention also applies to openings giving access to industrial equipment such as autoclaves or industrial cookers, and to pipes or valves in chemical, energy, or pharmaceutical installations, for example.

To this end, the invention relates to a static sealing gasket of elastically deformable type. The static sealing gasket of elastically deformable type has an axial direction X that is perpendicular to a join plane YZ. The gasket forms a closed loop around the direction X that is parallel to said join plane and presents a cross-section in each transverse half-plane defined by the axial direction X, each half-plane presenting a transverse direction Y in said join plane YZ.

According to the invention, the gasket comprises a single-piece body made of elastically deformable material, and such that each cross-section of the gasket at rest is a polygon that is not regular and that is transversely asymmetrical.

Each cross-section of the gasket at rest has:

a top sector extending from an internal surface of the top sector to an external backing surface that are spaced apart from the axial direction X respectively by a minimum internal dimension and by a maximum external dimension, the external backing surface externally defining an external transverse shoulder of the gasket;

a base sector of the gasket situated in elevation below the top sector, the base sector extending transversely from an internal base surface towards an external guide surface, which surfaces are spaced apart from the axial direction X respectively by a minimum internal measure and by a maximum external measure, the minimum internal measure and the maximum external measure being respectively smaller than the minimum internal dimension and the maximum external dimension, the external guide surface being separated from the external backing surface by an external transverse shoulder; and

the external transverse shoulder forming keying means for positioning purposes when mounting the gasket, the gasket including an internal holding lip that is integral with the single-piece body between the internal top surface and the internal base surface so as to project internally towards the axial direction X in order to block the gasket in the mounting position.

In an example of the invention, the gasket comprises:

an upper surface of the top sector that extends at rest in the transverse direction Y and perpendicularly to the external backing surface and to the internal top surface, the top surface providing sealing contact between the gasket in operation and the join plane YZ;

a lower surface of the base sector parallel at rest to the upper surface, perpendicular to the external guide surface and to the internal base surface and opposite to the upper surface in the axial direction X, the lower surface providing sealing contact between the gasket in operation and a bearing plane PJ for the gasket; and

an intermediate surface of the top sector arranged between the upper surface and the lower surface, forming the external transverse shoulder, the shoulder being perpendicular to the axial direction X and connecting the external backing surface to the external guide surface, a peripheral lowering setback being arranged at the bottom of the gasket from the external transverse shoulder to the lower surface, the guide surface being parallel to the axial direction X so as to direct mounting of the base sector in the axial direction X towards the bearing plane PJ.

In an embodiment, the holding lip possesses controlled deformation for external withdrawal in the transverse direction Y and includes at a higher location an elastic contact and holding arc after the gasket has been put in the mounting position.

In an embodiment, the gasket includes the single-piece body made of elastically deformable material having Young's modulus of the order of 1 MPa to 100 gigapascals (GPa), such that the external transverse shoulder is made integrally with said body.

In another embodiment, the gasket includes the body made of elastically deformable material having Young's modulus of the order of 1 MPa to 100 GPa and distinct rigid anti-extrusion ring, the anti-extrusion ring being adhesively fastened to the body to form an external partial outline of the top sector and the external backing surface, together with at least part of the shoulder.

In an example, the anti-extrusion ring is made of a material having hardness of at most 900 HV 0.3 (hardness on the Vickers scale) or 67 to 68 HRC (hardness on the Rockwell C scale) and selected from: steel, stainless steel, titanium, copper alloy, aluminum alloy, lead, polymer, aramid fiber, carbon fiber, glass fiber, graphite, ceramic.

In an example, the material of the body is made of an elastically deformable material selected from: fluoroelastomer, chloro-polyethylene rubber, chloro-sulfonated polyethylene rubber, epichlorohydrin rubber, ethylene acrylic rubber, ethylene propylene rubber, perfluorinated elastomers, tetrafluoroethylene, polychloroprene, nitrile rubber, silicone, or butyl rubber.

In an example, the gasket forms a closed loop of outline in the join plane YZ selected form: circle, oval, rectangle, square, and polygon.

In an example, the holding lip is intermittent along the closed loop of the gasket and comprises in alternation around this outline at least two holding sections projecting from the minimum measure of the base sector, and at least two setback sections flush with the minimum measure of the base sector in the transverse direction.

The invention further relates to a structure under positive pressure. The structure including at least one groove for receiving a static sealing gasket of elastically deformable type as mentioned. The positive pressure values of fluid in the structure in operation are of the order of 42 MPa to 75 MPa. The groove presents a cross-section that is not regular and that is asymmetrical comprising:

an upper through opening in the join plane for positioning the gasket in the groove;

a first external face facing the top sector so that the top sector bears against this first external face either of the external backing surface or of the anti-extrusion ring of such top sector;

a keying ring vertically in register with the bearing plane PJ in the axial direction X and projecting from the first external face towards the inside of the groove determining a horizontal face perpendicular to the axial direction X followed by a ramp sloping towards the bottom of the groove to facilitate inserting the base sector in the bottom of the groove then a second external face for guiding the external guide surface of the base sector until the base sector makes contact with the lower surface of the bearing plane PJ;

an internal face of the groove; and

a retaining barrier of the lip, projecting towards the outside of the groove in the transverse direction Y and from the internal wall.

The invention still relates to a method of mounting a sealing gasket in a structure as mentioned.

The method of the invention comprises:

a step of verifying matching of the gasket with a groove of the structure;

a step of verifying compatibility of at least one mark of the gasket with specifications for the structure;

a step of properly positioning the gasket in a groove of the structure, the cross-sections of the gasket and of the groove either allowing the gasket to be positioned properly or preventing the gasket from being positioned wrongly;

a holding step by interaction between a retaining barrier of the groove and the holding lip of the gasket; and

then, putting the gasket into a working position in the structure so as to obtain static sealing.

### BRIEF DESCRIPTION OF THE DRAWINGS

The invention and its advantages appear in greater detail from the context of the following description of embodiments given by way of illustration and with reference to the accompanying figures, in which:

FIG. 1 is an exploded perspective view of an example structure having four high pressure sealing gaskets installed respectively in four corresponding grooves;

FIG. 2 is a perspective view of a sealing gasket of the invention, provided on a top face with a mark, and with a holding lip for preventing the gasket from moving that is intermittent;

FIG. 3A is a fragmentary section view of an example assembly in accordance with the invention, showing a sealing gasket in a corresponding groove without any added anti-extrusion ring;

FIG. 3B is a view similar to FIG. 3A, but with an anti-extrusion ring added thereto;

FIG. 4 is a fragmentary section view of an example structure in accordance with the invention, in which there can be seen a high pressure sealing gasket installed in the corresponding groove;

FIG. 5 is a perspective view of a groove in a structure of the invention for receiving a sealing gasket;

FIG. 6 is a flow chart showing an example of a method of the invention for mounting a sealing gasket;

FIG. 7 is a fragmentary section view of an example of a sealing gasket wrongly mounted in a corresponding groove, with this being revealed by the method of the invention;

FIG. 8 is a fragmentary section view of an example sealing gasket of the invention in which a single-piece body includes an incorporated external guide surface;

FIG. 9 is another fragmentary section view of the FIG. 8 sealing gasket;

FIG. 10 is a fragmentary section view of an example sealing gasket of the invention in which an anti-extrusion ring is added to a single-piece body; and

FIG. 11 is another fragmentary section view of the FIG. 10 sealing gasket.

### DETAILED DESCRIPTION OF THE INVENTION

Elements present in more than one of the figures are given the same reference in each of them. In the figures, three mutually orthogonal directions X, Y, and Z are shown.

The direction X is to said to be “axial” insofar as components in the invention may have shapes of axial symmetry relative to the direction X in some examples. The terms “lower” or “upper” or indeed “middle” are defined relative to the axial direction X. The direction Y, which is perpendicular to the axial direction X, is said to be transverse, and the direction Z is the third component of an XYZ rectangular coordinate system. Conventionally, the term “lower” designates a location that is closer to the bottom of a groove while the term “upper” designates a location that is closer to a join plane. The terms “internal” or “external” are defined relative to one or another of the radial directions X or Y. Thus, “internal” indicates a location closer to an axis X, whereas “external” designates a location that is further away from an axis X.

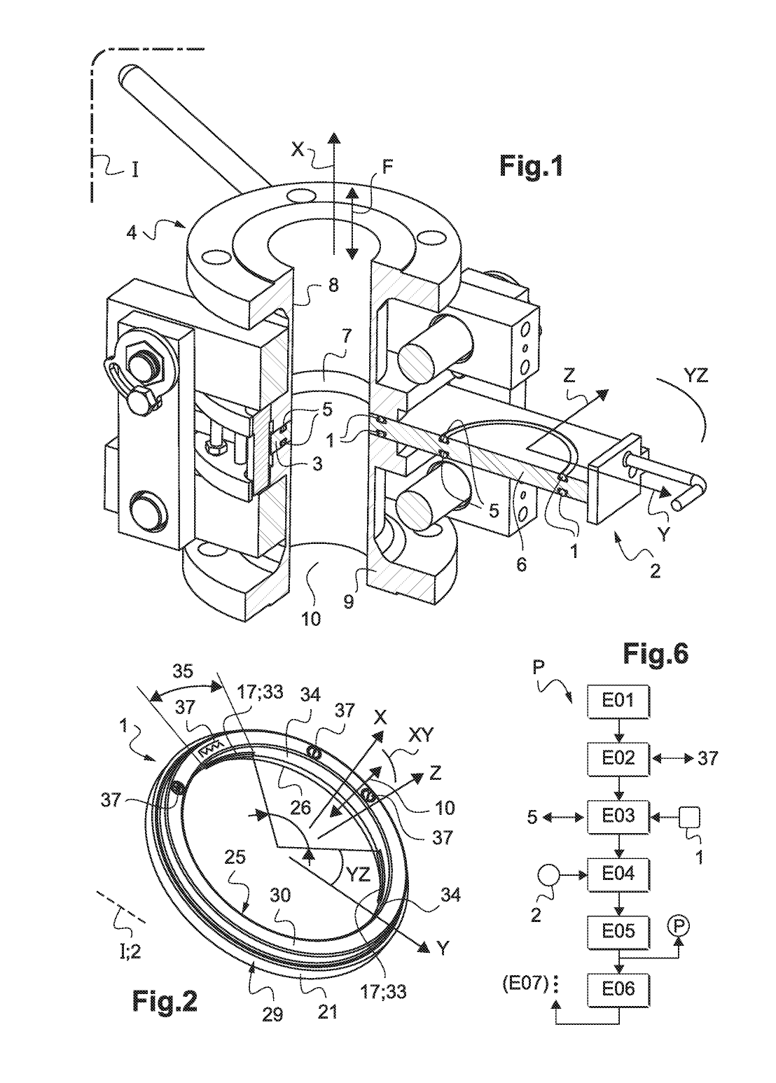

For example, FIG. 1 shows a join plane YZ that is parallel to the directions Y and Z, and a transverse half-plane XY that is parallel to the directions X and Y (or Z). In FIGS. 2-5 and 7-11, the transverse plane XY coincides with the plane of the sheet, and the join plane YZ is perpendicular to the plane of the sheet.

FIG. 1 shows an example of mounting a sealing gasket 1 on a structure 2. A method P (FIG. 6) explains how a sealing gasket 1 is mounted in accordance with the invention on such a structure 2. The structure 2 forms part of an installation I, shown in FIGS. 1 and 2.

In certain embodiments, at least one gasket 1 is incorporated in an installation I in the form of a pressurized vehicle (such as an aircraft or a submarine), within an access opening, such as a door or an airlock.

In other embodiments, the invention applies to structures 2 that are incorporated in access openings or in sealed junctions for industrial equipment such as autoclaves, industrial cookers, or other installations I. In other embodiments of the invention, a structure 2 having one or more gaskets 1 mounted therein is incorporated in other types of installation I in the chemical, oil, energy, pharmaceutical, or analogous industries.

In the examples of FIGS. 2-5, the structure 2 is incorporated in a pipe in an installation I, and more particularly in a valve 4 including a gate comparable to that shown in FIG. 1. In this figure, the structure 2 corresponds to a slidable gate 3 and the installation I to the rapid action valve 4.

Four deformable static sealing gaskets 1 are installed in four corresponding grooves 5 in the valve 3 that constitutes the structure 2 in this example. Two grooves 5 are provided in an upper face of the structure 2 and two other grooves 5 are provided in a lower face that is opposite from the upper face along the axial direction X.

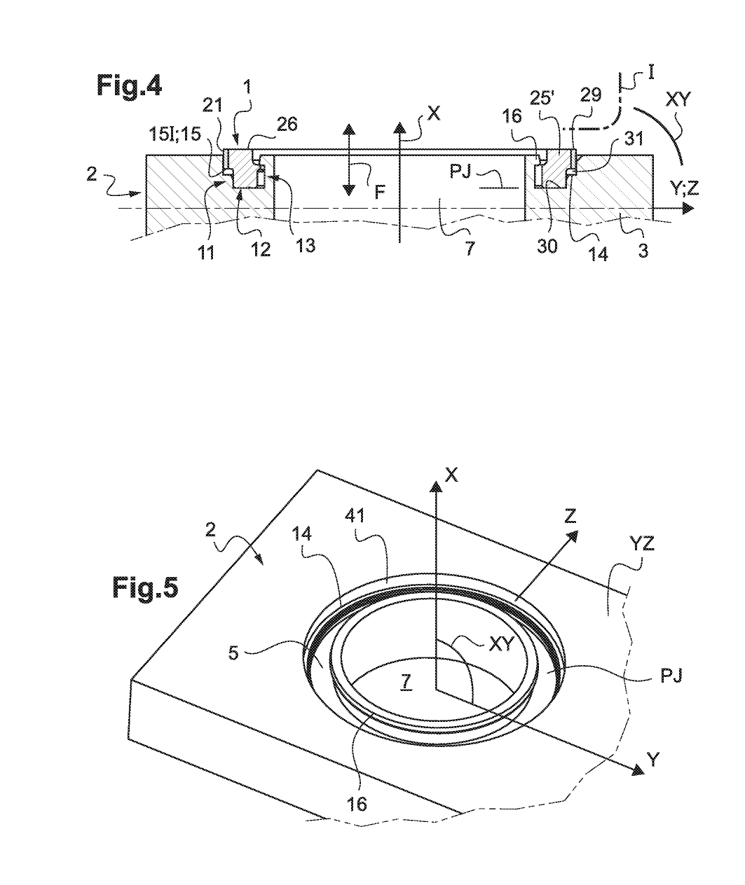

In FIG. 4, a gasket 1 of the invention is mounted in a groove 5 in an upper face of the gate 3. One “upper” groove 5 surrounds a shut-off web 6 (visible in FIG. 1) for interrupting a stream F of fluid under pressure, and another upper groove 5 surrounds a through port 7 for passing the stream F in an upper face of the gate 3. In the other, or “lower”, face, there is a gasket 1 (not shown) of the invention that is similarly mounted in a lower groove 5 and surrounds the shut-off web 6, and another gasket that surrounds the through passage 7.

In operation, the structure 2 of FIG. 1 is abutted between an upstream segment 8 of an installation I, such as the valve 4, and a downstream segment 9. These segments 8 and 9 are hollow and together with the port 7 they define a passage 10 in the form of a pipe for a stream F of fluid under pressure, which may be in the form of a solid (powder, . . . ), liquid, or gas. These upstream and downstream segments 8 and 9 are rigidly fastened to each other and hermetically clamped against the structure 2 in operation, in releasable manner.

In operation, the structure 2 of the invention, as shown in FIG. 4, is a gate 3 abutted between an upstream segment and a downstream segment of an installation I formed by the valve 4. These upstream and downstream segments are rigidly and hermetically fastened to the structure 2 in operation, naturally in separable manner.

Specifically, the gasket 1 and the structure 2 of the invention are designed to withstand large positive pressures in operation. The invention makes it possible for the fluid pressure to which the gasket 1 of the structure 2 are subjected to reach positive values of the order of 42 MPa to 75 MPa.

FIG. 2 shows an example of a sealing gasket 1 of the invention suitable for mounting on any structure 2 within an installation I, such as those shown in FIG. 1, or different therefrom.

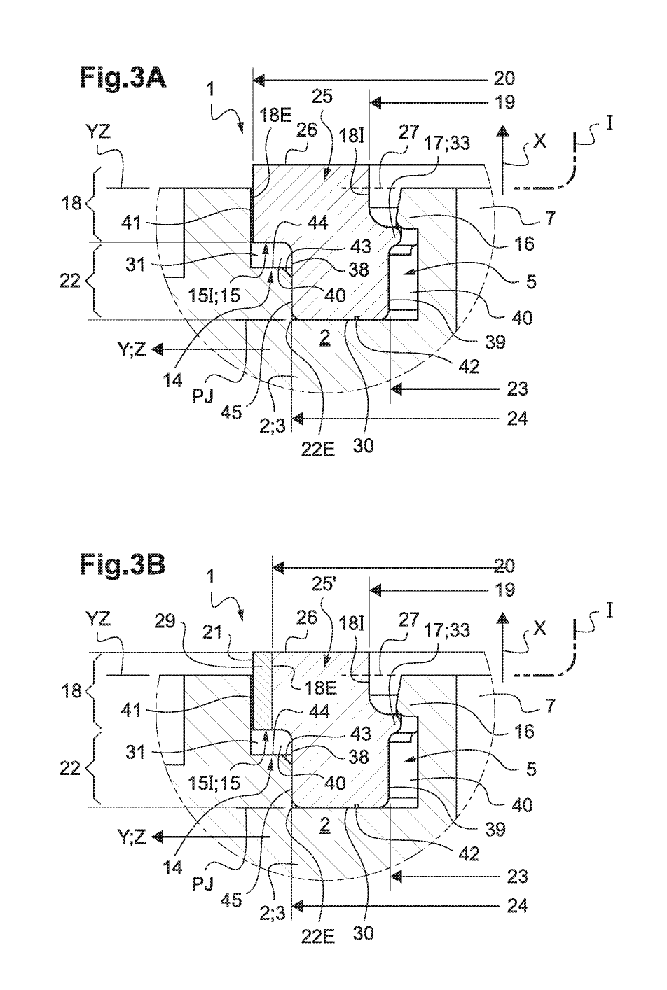

In the examples of FIGS. 3A and 3B, the structure 2 of the invention possesses at least one groove 5 that presents a specific cross-section in a half-plane XY, and in co-operation with a corresponding number of gaskets 1, the grooves ensure remarkable ability to withstand pressure and to improve safety against mounting errors, in particular.

In the invention, the sealing gasket 1 is of the static type and it is elastically deformable. The gasket 1 in the working position generally extends in a plane that corresponds to the join plane YZ.

In this join plane YZ, the gasket 1 forms a closed loop (circular in the example of FIG. 2). The fluid passage 10 extends along the axial direction X in FIG. 2.

In this example, the gasket 1 forms a closed loop of circular outline in the join plane YZ. The gasket 1 is then a body of revolution about the direction X.

In other embodiments, the closed loop shape of the gasket 1 may be oval, rectangular, square, or polygonal, by way of non-exclusive examples. In such embodiments, angles or bends present some minimum radius of curvature, e.g. between two rectilinear zones of a rectangular outline.

In the transverse plane XY and in contrast with O-rings, the gasket 1 of the invention presents a cross-section that is not circular, nor is it triangular, nor is it rectangular. In simple terms, the cross-section of the gasket 1 of the invention is contained in a transverse plane XY.

In the invention, the cross-section of the gasket 1 at rest is in the form of a polygon that is not regular and that is asymmetrical relative to the axial direction X, and also relative to the transverse direction Y. Each groove 5 has an external face 11, a lower face 12, an internal face 13, a keying rim 14, and a retaining barrier 16, as can be seen in FIG. 4.

As explained below, the gasket 1 is made to be asymmetrical by the presence in particular of an external transverse shoulder 15 and of an internal holding lip 17, that can be seen in FIGS. 3A and 3B, for example.

With reference to FIGS. 3A and 3B, it can be seen that the gasket 1 at rest presents the following in the transverse plane XY:

a top sector 18 extending from an internal surface 181 of the top sector 18 to an external backing surface 18E that are spaced apart in the axial direction X by a minimum internal dimension 19 and by a maximum external dimension 20, the external backing surface 18E externally defining an external transverse shoulder 15 of the gasket 1;

a base sector 22 of the gasket 1 situated in elevation in part below the top sector 18, the base sector extending transversely from an internal base surface 39 towards an external guide surface 38 that are spaced apart along the axial direction X by a minimum internal measure 23 and by a maximum external measure 24, the minimum internal measure 23 and the maximum external measure 24 being respectively less than the minimum internal dimension 19 and the maximum external dimension 20, the external guide surface 38 being spaced apart from the external backing surface 18E by the external transverse shoulder 15; and

the external transverse shoulder 15 forming keying means for positioning purposes when mounting the gasket 1, the gasket 1 including an internal holding lip 17 that is integral with the body 25, 25′ between the internal surface 181 of the top and the internal base surface 39 so as to project internally towards the axial direction X in order to block the gasket 1 in the mounting position.

In FIG. 3A, the top sector 18 has an outer backing surface 18E and an inner top surface 181. The base sector 22 also has an external guide surface 38 and an internal base surface 39.

FIG. 3A shows that the (minimum internal) measure 23 and the (maximum external) measure 24 are respectively smaller than the (minimum internal) dimension 19 and the (maximum external) dimension 20. Consequently, the top sector 18 is offset towards the outside relative to the base sector 22. As a result, the top sector 18 is offset externally (in the Y direction) relative to the base sector 22, thereby creating transverse asymmetry.

In the transverse direction Y, the backing surface 18E of the top sector 18 thus does not overlie the base sector 22. The shoulder 15 thus essentially projects from the base sector 22 transversely towards the outside of the gasket 1.

In other words, the maximum external measure 24 extends internally at a distance from under the external transverse shoulder 15. The minimum internal measure and dimension 19 and 23 extend internally offset from the internal holding lip 17 in the transverse direction Y. Consequently, the invention provides asymmetrical keying means against any risk of mounting the gasket 1 upside-down.

In FIG. 2 or 3A, the gasket 1 has a single-piece body 25. The single-piece body 25 forms the top sector 18 and the base sector 22. Thus, the single-piece body 25 defines an upper surface 26 of the gasket 1 between the external ends of the dimensions 19 and 20.

It can be seen in FIG. 4 that the surface 26 of the body 25 at rest extends in the transverse direction Y (and naturally in the direction Z).

In the mounting position, the surface 26 projects beyond a top through opening 27 of the groove 5, as can be seen in FIGS. 3A and 3B. This surface 26 and thus the top of the gasket 1 project by 0.5 mm to 4 mm from the opening 27, i.e. from the join plane YZ of this structure 2 in the mounting position. It can thus be understood that in operation the upper surface 26 generally extends flush with the opening of the structure 2, in the YZ join plane.

The lip 17 is incorporated in the body 25, 25′ and lies between the base sector 22 and the top sector 18, so as to project in the transverse direction Y towards the inside of the gasket 1, i.e. directed towards the direction Y in order to hold the gasket 1 in the mounting position.

Consequently, the body 25, 25′ incorporates the base sector 22, the lip 17, the shoulder 15, and thus the top sector 18, which are made integrally with one another.

It should be observed that the body 25 forms a central core 28 (shown in dashed lines in FIGS. 9 and 11) extending axially from top to bottom of the gasket 1 and over a transverse width lying in the range 50% to 60% of the distance between the external backing surface 18E and a transverse end of the lip 17. By means of its axial dimensions, from the surface 26 to the bearing plane PJ, the core 28 is less sensitive to deformation than are the shoulder 15 and the lip 17. In operation, it is in register with this core 28, and because of its elasticity sealing is provided by urging the surface 26 against the structure 2 in the join plane YZ and between the base sector 22 and the bearing plane PJ of the groove 5.

By way of example, the body 25, 25′ is molded out of elastically deformable material. In the embodiment of FIGS. 2 to 4, the elastically deformable material of the body 25, 25′ presents a Young's modulus lying in the range about 1 MPa to 100 GPa.

One of the purposes of this is to ensure that the holding lip 17 possesses controlled deformation in external withdrawal in the transverse direction Y. This makes it possible to ensure that the gasket 1 is put into place and held in place in the corresponding groove 5. Similarly, this modulus is designed so as to obtain controlled deformation of the shoulder 15.

By way of example, the body 25, 25′ may be made of an elastically deformable material selected from: FKM or FFKM fluoroelastomer, chloro-polyethylene rubber, chloro-sulfonated polyethylene rubber, epichlorohydrin rubber, ethylene acrylic rubber, ethylene propylene rubber, or perfluorinated elastomers, tetrafluoroethylene, polychloroprene, nitrile rubber, silicone, or butyl rubber.

For example, the material is a polymer of Viton® type having hardness of 70 to 90 on the Shore scale from the supplier Dupont. This material presents in particular hardness on the Shore A scale of 70±5 tested at 72, minimum tensile stress of 12.31 MPa, minimum accepted elongation of 175% tested up to 211%, and a Young's modulus at 100% of 6.24 MPa.

FIGS. 8 and 9 and FIGS. 10 and 11 show two embodiments of the gasket 1, and in particular of the body 25, 25′.

In FIGS. 8 and 9, the gasket 1 is a single piece and constituted by the body 25 made of elastically deformable material, such that the external transverse shoulder 15 and the holding lip 17 are made together integrally. Consequently, the body 25 defines the external guide surface 38. In such an embodiment, the integrally made external backing surface 18E may be subjected to surface treatment seeking to prevent it from hardening, e.g. by local photochemical reaction, locally printing a coating, locally depositing a coating, or the like.

In FIGS. 10 and 11 (and 2, 3B to 4, 7), the gasket 1 includes the body 25 made of elastically deformable material and an added anti-extrusion ring 29. This anti-extrusion ring 29 is rigid, distinct from the body 25, and extends the shoulder 15.

In these embodiments, the anti-extrusion ring 29 is fastened adhesively so as to form the outline of the top sector 18 like a belt. The external surface 21 of this anti-extrusion ring 29 thus comes transversely at the end of the shoulder 15.

In the example of FIG. 3B, and as mentioned above, the anti-extrusion ring 29 externally extends the top sector 18 in the direction Y and thus contributes to enlarging the external transverse shoulder 15 and to putting the gasket in place during assembly and then in operation.

In certain embodiments, the anti-extrusion ring 29 is made of a material having hardness of at most 900 HV 0.3 on the Vickers hardness scale or 67 to 68 HRC on the Rockwell C hardness scale, and it is selected from: steel, stainless steel, titanium, copper alloy, aluminum alloy, lead, polymer, aramid fiber, carbon fiber, glass fiber, graphite, ceramic.

An object of this stiffness is to ensure that the periphery of the gasket 1 is held effectively inside the groove 5 when passing from the mounting position to the working position so that the anti-extrusion ring 29 performs an anti-extrusion function. The term “anti-extrusion” function is used to mean that it avoids any risk of the elastically deformable material migrating onto the upper or lower faces of a structure 2, such as a slidable gate 3, for example.

In the invention, the upper surface 26 of the top sector 18 provides sealing contact of the gasket 1 in operation in the join plane YZ. The gasket 1, and in particular the body 25, 25′, also presents a lower surface 30 that is parallel to the upper face 26, at rest. The surface 30 is opposite from the surface 26 in the axial direction X and provides sealing contact of the gasket 1 in operation with the bottom of the groove 5, against the bearing plane PJ.

Between the surface 30 and the external guide surface 38 of the gasket 1, there is formed a centering chamfer 22E (FIGS. 8 to 11) making it easy for the gasket 1 to penetrate into the bottom of the groove 5 of the structure 2, given the associated effect of a ramp 43 of said structure 2, as described below. This centering chamfer 22E thus participates in putting the base sector 22 of the gasket 1 properly into position, with the external surface 38 performing a guide function.

FIGS. 3A and 4 show that the positioning of the gasket 1 on mounting in the groove 5 leaves free a peripheral setback 31 for lowering. This peripheral lowering setback 31 is located at the bottom of the gasket 1 between the shoulder 15 and the lower surface 30. The setback 31 is axially under the outer backing surface 18E.

Because of the controlled deformation of the material of the body 25, 25′ on passing from the mounting position to the working position, the external backing surface 18E directs the deformation of the shoulder 15 along the axial direction X and towards the bearing plane PJ so that the shoulder moves down and occupies the setback 31, in part.

As shown in FIG. 3B, the external surface 21 of the anti-extrusion ring 29 guides this deformation of the shoulder 15.

In other words, the surfaces 18E and 21 govern the deformation of the shoulder 15 to its working position, along the axial direction X and towards the bottom of the groove 5 (i.e. towards the bearing plane PJ) and inside the setback. This contributes to providing highly sealed contact at the surfaces 26 and 30, and thus of the core 28. In comparison with prior art gaskets, the extent made available by the invention is particularly large both in the join plane YZ and in the gasket bearing plane PJ, i.e. perpendicularly to the axial direction X. Specifically, because of these surfaces 26 and 30 of large dimensions where static sealing takes place between the gasket 1 and the structure 2, the invention provides presently unequalled safety, in particular against large pressures.

The function of the holding lip 17 is to block the gasket 1 in the groove 5 during mounting. The holding lip 17 is in the form of a hoop in upper, lower, and transverse locations of the lip 17.

In FIGS. 8 and 10, the lip 17 presents a contact arc 32 that is elastic and prevents movement after the gasket 1 has been put into position in the groove 5. It can be understood that because of its rounded shape, the lip 17 can be inserted for clipping in the groove 5. This arc 32 thus avoids subjecting the gasket 1 to bruises and to incipient cracks while it is being mounted in the groove 5, which implies controlled deformation of the lip 17.

In the axial direction X, the lip 17 extends for the most part within the top sector 18, only the compensating curvature at the bottom of the lip 17 being situated within the base section 22.

In embodiments of the invention, the holding lip 17 is continuous along the closed loop of the gasket 1, i.e. the lip 17 extends over the entire internal periphery of the body 25, 25′ and thus of the gasket 1.

In the embodiment of the invention shown in FIG. 2, the holding lip 17 is intermittent along the closed loop of the gasket 1 and comprises in alternation around this outline at least two holding sections 33 or hoops projecting transversely inwards from the minimum measure 23. At least two set-back sections 34 are flush with the minimum measure 23 of the base sector 22 in the transverse direction Y.

In this embodiment, each holding section 33 has an angular extent 35, e.g. of the order of 30°±20°. Each set-back section 34 extends over a spacing angle 36, e.g. of the order of 120°±10°.

In FIG. 2, various marks 37 are applied to the body 25. In FIG. 2, the marks are applied to the lower surface 30 of the gasket. In FIGS. 3A, 3B, and 7-9, reference 42 corresponds to the trace of a mark 37.

In this embodiment, at least one of the marks 37 is obtained by injection molding the body 25. In other embodiments, at least one other mark 37 is made after the body 25 has been molded, e.g. by hot-stamping, or the like.

In FIGS. 8 and 10, the mark is preferably formed on the upper surface 26 in order to be visible once the gasket 1 has been mounted.

In this type of embodiment, the arrangement of a plurality of marks 37 is comparable to that of FIG. 2 where one mark 37 (on the left) is a date identifying the production date of the gasket 1, typically by injection molding (a dial having 12 numbers and a central alphanumeric identifier). Another mark 37, referred to as a “central” mark indicates the nature of the material of the elastically deformable gasket 1 and is in the form of a dial having 12 numbers. An additional mark 37 (on the right) is an indicator of the hardness of the elastically deformable material and it is in the form of a dial having 12 numbers. Naturally, other marks are possible.

In FIGS. 8 to 11, it can be seen that the shape junction between the shoulder 15 and the guide surface 38 of the gasket 1, as defined by the body 25, 25′ is concave and rounded. Similarly, the junctions between the external guide surface 38 and the lower surface 30, and also between the surface 30 and an internal base surface 39 are convex and rounded, thereby constituting respective centering chamfers 22E. This seeks to facilitate mounting and avoids bruising the gasket.

Prior to describing the structure 2, it should be observed in FIGS. 3A, 3B, and 4, where the gasket is at rest, there is an empty expansion volume 40 for the gasket 1 in its groove 5.

In cross-section, relative to the surface of the gasket 1, this volume 40 is about 12%. FIGS. 3A, 3B show that this volume 40 is subdivided into two portions on either side of the central core 28. The volume 40 has an external portion, namely the peripheral lowering setback 31 between the groove 5 and the external guide surface 38, and also an internal portion between the internal base surface 39 (FIGS. 8 to 11) and the groove 5.

With reference to FIGS. 3 to 5, it can be seen that the structure 2, and in particular each groove 5, presents a cross-section that is in the form of a polygon that is not regular and that is asymmetrical in the axial direction X and the transverse direction Y.

The groove 5 has an upper through opening 27 in the join plane YZ for putting the gasket 1 into position in the groove 5. The groove 5 possesses an internal face 13 and a keying rim 14 situated vertically towards the bottom of the groove 5 in the axial direction X, i.e. towards the bearing plane PJ and projecting from a first external bearing face 41 towards the inside of the groove 5 along the transverse direction Y (FIGS. 3A, 3B, and 4).

In the invention, each external bearing face 41 is arranged to bear against and guide in sliding either the external surface 21 of the anti-extrusion ring 29 (FIG. 3B) or else the external backing surface 18E of the gasket 1 (FIG. 3A).

The keying rim 14 has a horizontal face 44 perpendicular to the axial direction X, followed by a ramp 43 sloping towards the bottom of the groove 5 in order to facilitate insertion of the base sector 22 into the bottom of the groove 5, by co-operating with the centering chamfer 22E of the base sector 22. This ramp is itself followed by a second external face 45 for guiding the external guide surface 38 of the base sector 22 until this base sector 22 comes into contact with the bearing plane PJ at the bottom of the groove 5.

In the invention, each groove 5 has a retaining barrier 16 for co-operating with the lip 17. This barrier 16 projects towards the outside of the groove 5 in the transverse direction Y and from an internal wall 13 that forms the internal face 13 of the groove 5. This barrier 16 serves to provide retention by resilient clipping, thereby holding the gasket 1 in the groove 5.

With reference to FIG. 6, there follows a description of the mounting method P of the invention. This method P comprises: a step E01 of verifying that the gasket 1 matches a groove 5 of the structure 2;

a step E02 of verifying compatibility between at least one mark 37 of the gasket 1 and the specifications of the structure 2;

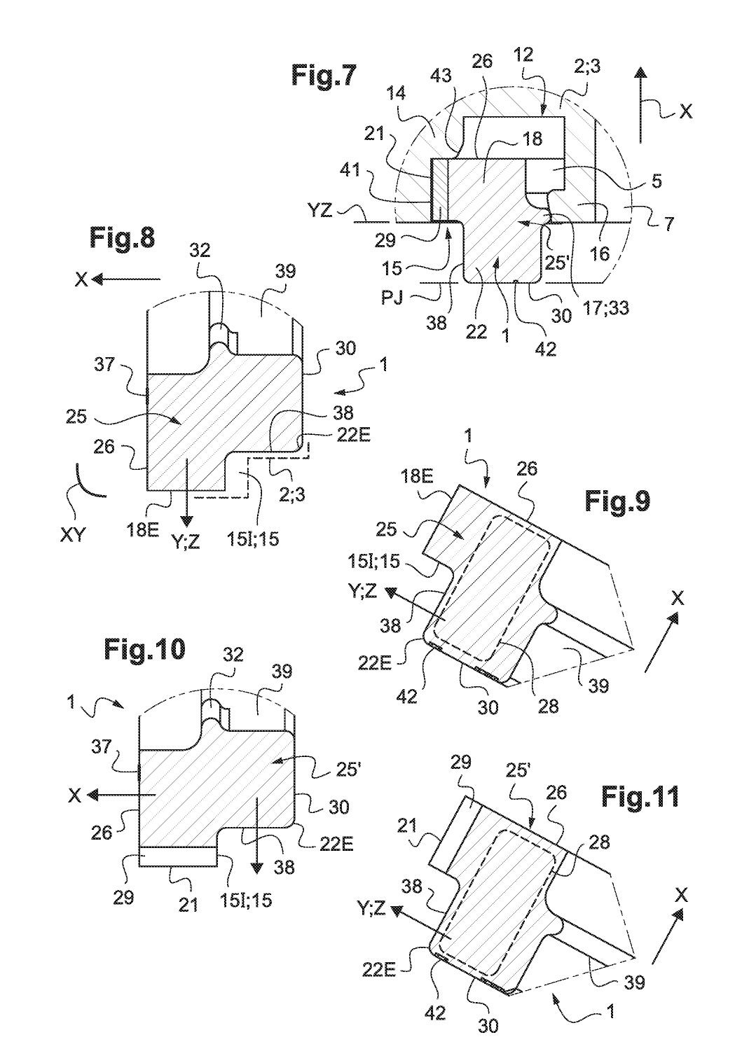

a step E03 of properly positioning the gasket 1 in a groove 5 of the structure 2, the cross-sections of the gasket 1 and of the groove 5 allowing the gasket to be put into position properly or preventing it from being put into position wrongly (see comments below relating to FIG. 7);

a holding step E04 of interaction between the retaining barrier 16 and the holding lip 17; and

thereafter a step E05 of putting the gasket 1 into its working position in the structure 2, so as to obtain static sealing.

Where appropriate, and as shown in FIG. 6, the method P includes a step E06 of withdrawing the gasket 1 from the groove 5, e.g. for a maintenance operation that may be regular, exceptional, or programmed. When changing the gasket 1, the method then includes a step E07 of returning to the beginning of the method P.

In order to illustrate the step E03 of properly positioning the gasket 1 in a groove 5 of the structure 2, FIG. 7 shows an example of a sealing gasket 1 wrongly mounted in a corresponding groove 5, with this being revealed by the method of the invention.

Specifically, it can be seen that the gasket 1 does not penetrate correctly into the groove 5, leaving a gap between the lower face 12 of the groove 5 and the (normally upper) surface 26 of the gasket. Likewise, the lip 17 does not go past the barrier 16, since it remains essentially in an insertion chamfer. Under such circumstances, with the gasket being wrongly mounted since it is turned transversely through 180° relative to its proper mounting position, controlled deformation of the gasket 1 is not possible. Specifically, any clamping of a part sharing the join plane YZ with the structure 2 is impossible, the base sector 22 remaining outside the groove 5 and constituting an obstacle to the part and the structure 2 being moved towards each other and towards the join plane YZ.

By means of the invention, static sealing between an upstream segment and a downstream segment of a length of pipe for fluid under high pressure is obtained that can also operate at a temperature lying in the range −100° C. to +320° C. for the fluid flowing in the structure 2.

Unlike prior art sealing, the invention advantageously makes it possible for an empty expansion volume of about 12% to be provided at rest for a gasket 1 in its polygonal groove 5 having a shoulder and a lip. This empty volume allows excellent expansion of the gasket 1 in its groove 5 and ensures that the portions of the gasket 1 are well distributed when it deforms in the volumes that are empty at rest, during expansion that facilitates the gasket 1 obtaining a deformed outline that is certain to guarantee sealing.

The invention guarantees static sealing that is durable and reliable, even when the pressure of the fluid in the structure 2 exceeds particularly high values.

Furthermore, during mounting in situ, the invention avoids human errors both concerning the model of the gasket 1 that is to be installed in a given groove 5 (e.g. a gasket of inappropriate shape).

The invention also prevents a gasket of acceptable shape but made of inappropriate material(s) being installed as a result of a human error, since the marking makes it possible to verify compatibility and also to verify that the gasket 1 has an appropriate limit date.

With the invention, it is easy in practice to be certain that the appropriate gasket 1 is properly installed in situ. Also, because of its cross-section that is not circular and that presents right and wrong directions for mounting the gasket 1 in the corresponding groove 5, it is now easy to be certain that the gasket 1 is mounted inside the groove 5 in a proper position and in a proper manner.

Furthermore, because of the holding lip, the invention guarantees that the gasket 1 at rest is held inside the groove 5 from the moment it is mounted and until sealing is obtained. When clamping from the rest state to the working state, the invention ensures that the gasket 1 is deformed progressively and in distributed manner, thereby avoiding harm to its integrity. In particular, the gasket 1 of the invention no longer runs the risk of being bruised or damaged insofar as the shape with rounded corners in section of the gasket 1 ensures that it is inserted gently into the groove 5. This avoids incipient cracks.

Furthermore, the gasket 1 is particularly robust, simple, and compact, while being capable of being produced economically, typically by injection molding, even for limited runs.

Naturally, the invention may be subjected to variations as to its implementation. Although several embodiments are described, it is not conceivable to identify exhaustively all possible embodiments of the invention. Thus, certain embodiments make provision for replacing any of the means described by equivalent means while remaining within the ambit of the invention.

TABLE 1

| Reference | Description |
|---|---|
| X | axial direction |
| Y | transverse direction |
| Z | radial direction |
| XY | transverse plane |
| YZ | join plane |
| PJ | gasket bearing plane |
| F | fluid stream |
| P | mounting method |
| I | installation |
| E01 | step of verifying matching |
| E02 | step of verifying compatibility |
| E03 | positioning step |
| E04 | holding step |
| E05 | pressurizing step |
| E06 | gasket removal step |
| E07 | step of returning to the start of the method |
| 1 | sealing gasket |
| 2 | structure |
| 3 | slidable guide |
| 4 | assembly e.g. valve |
| 5 | groove |
| 6 | shut-off web |
| 7 | through port |
| 8 | upstream segment |
| 9 | downstream segment |
| 10 | fluid passage |
| 11 | external face |
| 12 | lower face |
| 13 | internal face |
| 14 | keying rim |
| 15 | external transverse shoulder |
| 15I | intermediate surface |
| 16 | retaining barrier |
| 17 | internal holding lip |
| 18 | top sector |
| 18I | internal top surface |
| 18E | external backing surface |
| 19 | minimum internal dimension |
| 20 | maximum external dimension |
| 21 | external ring surface |
| 22 | base sector |
| 22E | centering chamfer |
| 23 | minimum internal measure |
| 24 | maximum external measure |
| 25, 25′ | body |
| 26 | upper surface |
| 27 | upper through opening |
| 28 | central core |
| 29 | anti-extrusion ring |
| 30 | lower surface |
| 31 | peripheral lowering setback |
| 32 | contact arc |
| 33 | projecting holding sections or hoops |
| 34 | setback sections |
| 35 | angular extent |
| 36 | spacing angle |
| 37 | mark |
| 38 | external guide surface |
| 39 | internal base surface |
| 40 | empty expansion volume |
| 41 | first external bearing face |
| 42 | mark |
| 43 | sloping ramp |
| 44 | horizontal face |
| 45 | second external face |

What is claimed is:

1. A static sealing gasket of an elastically deformable type, the gasket extending in elevation parallel to an axial direction perpendicular to a join plane, the gasket forming a closed loop around the axial direction and presenting a cross-section in each transverse half-plane defined by the axial direction, each half-plane presenting a transverse direction in the join plane, wherein the gasket comprises a body made of elastically deformable material, each cross-section of the gasket at rest being a polygon that is not regular and that is transversely asymmetrical, each cross-section comprising:
a top sector extending from an internal surface of the top sector to an external backing surface that are spaced apart from the axial direction respectively by a minimum internal dimension and by a maximum external dimension, the external backing surface externally defining an external transverse shoulder of the gasket;
a base sector of the gasket situated in elevation in part below the top sector, the base sector extending transversely from an internal base surface towards an external guide surface, which surfaces are spaced apart from the axial direction respectively by a minimum internal measure and by a maximum external measure, the minimum internal measure and the maximum external measure being respectively smaller than the minimum internal dimension and the maximum external dimension, the external guide surface being separated from the external backing surface by an external transverse shoulder; and
an external transverse shoulder forming keying means for positioning purposes when mounting the gasket, the gasket including an internal holding lip that is integral with the body between the internal top surface and the internal base surface so as to project internally towards the axial direction in order to block the gasket in the mounting position.

2. A gasket according to claim 1, wherein the gasket comprises:
an upper surface of the top sector that extends at rest in the transverse direction and perpendicularly to the external backing surface and to the internal top surface, the top surface providing sealing contact between the gasket in operation and the join plane;
a lower surface of the base sector parallel at rest to the upper surface, perpendicular to the external guide surface and to the internal base surface and opposite to the upper surface in the axial direction, the lower surface providing sealing contact between the gasket in operation and a bearing plane for the gasket; and
an intermediate surface of the top sector arranged between the upper surface and the lower surface, forming the external transverse shoulder, the shoulder being perpendicular to the axial direction and connecting the external backing surface to the external guide surface, a peripheral lowering setback being arranged at the bottom of the gasket from the external transverse shoulder to the lower surface, the guide surface being parallel to the axial direction so as to direct mounting of the base sector in the axial direction towards the bearing plane.

3. A gasket according to claim 1, wherein the holding lip possesses controlled deformation for external withdrawal in the transverse direction and includes at a higher location an elastic contact and holding arc after the gasket has been put in the mounting position.

4. A gasket according to claim 1, wherein the gasket is a single piece and is constituted by the body of elastically deformable material having Young's modulus of the order of 1 MPa to 100 GPa, such that the external transverse shoulder is made integrally with the body.

5. A gasket according to claim 1, wherein the gasket includes the body made of elastically deformable material having Young's modulus of the order of 1 MPa to 100 GPa and distinct rigid anti-extrusion ring, the anti-extrusion ring being adhesively fastened to the body to form an external partial outline of the top sector and the external surface of the anti-extrusion ring, together with at least part of the shoulder.

6. A gasket according to claim 5, wherein the anti-extrusion ring is made of a material having hardness of at most 900 HV 0.3 (hardness on the Vickers scale) or 67 to 68 HRC (hardness on the Rockwell C scale) and selected from: steel, stainless steel, titanium, copper alloy, aluminum alloy, lead, polymer, aramid fiber, carbon fiber, glass fiber, graphite, ceramic.

7. A gasket according to claim 1, wherein the material of the body is made of an elastically deformable material selected from: fluoroelastomer, chloro-polyethylene rubber, chloro-sulfonated polyethylene rubber, epichlorohydrin rubber, ethylene acrylic rubber, ethylene propylene rubber, perfluorinated elastomers, tetrafluoroethylene, polychloroprene, nitrile rubber, silicone, or butyl rubber.

8. A gasket according to claim 1, wherein the gasket forms a closed loop of outline in the join plane, the closed loop being selected from the group consisting of a circle, an oval, a rectangle, a square, and a polygon.

9. A gasket according to claim 1, wherein the holding lip is intermittent along the closed loop of the gasket and comprises in alternation around this outline at least two holding sections projecting from the minimum measure of the base sector, and at least two setback sections flush with the minimum measure of the base sector in the transverse direction.

10. A gasket according to claim 1, wherein the gasket includes a centering chamfer between the external guide surface and the lower surface.

11. A structure under positive pressure, the structure including at least one groove, wherein a static sealing gasket of elastically deformable type according to claim 1 is arranged in the groove, the positive pressure values of fluid in the structure in operation being of the order of 42 MPa to 75 MPa, the groove presenting a cross-section that is not regular and that is asymmetrical, the structure comprising:
an upper through opening in the join plane for positioning the gasket in the groove;
a first external face facing the top sector so that the top sector bears against this first external face either of the external backing surface or of the external surface of the anti-extrusion ring;
a keying ring vertically in register with the bearing plane in the axial direction and projecting from the first bearing face towards the inside of the groove determining a horizontal face perpendicular to the axial direction followed by a ramp sloping towards the bottom of the groove to facilitate inserting the base sector in the bottom of the groove then a second external face for guiding the external guide surface of the base sector until the base sector makes contact with the bearing plane at the bottom of the groove;
an internal face of the groove; and
a retaining barrier of the lip, projecting towards the outside of the groove in the transverse direction and from the internal face.

12. A method of mounting a sealing gasket according to claim 1 in a structure, wherein the method comprises:
a step of verifying matching of the gasket with a groove of the structure;
a step of verifying compatibility of at least one mark of the gasket with specifications for the structure;
a step of properly positioning the gasket in the groove of the structure, the cross-sections of the gasket and of the groove either allowing the gasket to be positioned properly or preventing the gasket being positioned wrongly;
a holding step by interaction between a retaining barrier of the groove and the internal holding lip of the gasket; and
then, putting in the structure the gasket into a working position so as to obtain static sealing.
